(19) United States
(12) Patent Application Publication
(10) Pub. No.: US 2013/0106688 A1
(43) Pub. Date: May 2, 2013

(54) IMAGE INFORMATION PROCESSING APPARATUS

(71) Applicant: Buffalo, Inc., Nagoya-shi (JP)

(72) Inventors: Hayato KATO, Nagoya-shi (JP); Hiroaki KAWASAKI, Nagoya-shi (JP); Kenji TAKAHASHI, Nagoya-shi (JP); Yutaka MARUYAMA, Nagoya-shi (JP)

(73) Assignee: Buffalo, Inc., Nagoya-shi (JP)

(21) Appl. No.: 13/656,026

(22) Filed: Oct. 19, 2012

(30) Foreign Application Priority Data
Nov. 2, 2011 (JP) 2011-241533

(51) Int. Cl. G06T 1/60; G06F 3/01

(52) U.S. Cl. 345/156; 345/530

(57) ABSTRACT

An information processing apparatus including a database that stores a condition associated with first information; a memory that stores image data and second information associated with the image data; and a processor that compares the second information to the condition, determines that the second information matches the condition based on the comparison, and associates the first information with the image data based on the determination.

### CROSS REFERENCES TO RELATED APPLICATIONS

The present application claims priority to Japanese Patent Application No. 2011-241533 filed on Nov. 2, 2011, the disclosure of which is hereby incorporated by reference in its entirety.

### BACKGROUND OF THE DISCLOSURE

1. Field of the Disclosure

The present disclosure relates to an image information processing apparatus configured to attach additional information to image data and a computer-readable non-temporary recording media storing programs.

2. Description of the Related Art

With the recent remarkable lowering of the cost of recording media, users have come to store masses of image data, audio data, text data, and other types of content data. This trend requires the appropriate management of these masses of content data. For example, Japanese Patent Laid-open No. 2004-312244 discloses a method of recording captured images indicative of a same attribute to one recording folder in a collective manner, thereby facilitating the management of captured images.

In addition, Japanese Patent Laid-open No. 2010-072818 discloses a technology of generating, for each photograph, information about user's “degree of everydayness” at the time a photograph concerned was taken from information of the distinction between weekday and holiday or location of photograph taking for example in a digital photo frame configured to accumulate image data for display and relating the generated information with each photograph. The information about “degree of everydayness” is a parameter indicative of the degree of how much a user's current situation is daily (ordinary, common, or routine). This information is used for such processing as preferentially reproducing photographs depicting non-ordinary scenes such as those of sightseeing tours, for example.

However, if a user is required to attach additional information such as attributes for example, the ease of operation and convenience is lowered. Besides, displaying image data on the basis of the degree of everydayness causes photographs taken at different travel locations at different times for example to be all sorted as “extraordinary” photographs, thereby disabling the searching for photographs of particular events to lower user convenience.

Therefore, the present disclosure addresses the above-identified and other problems associated with related-art methods and apparatuses and solves the addressed problems by providing an image information processing apparatus configured to enhance user convenience and a computer-readable, non-temporary recording media in which a program configured to enhance the user convenience is stored as one of the purpose of the present disclosure.

### SUMMARY

In carrying out the disclosure and according to one aspect thereof, there is provided an image information processing apparatus including a database that stores a condition associated with first information; a memory that stores image data and second information associated with the image data; and a processor that compares the second information to the condition, determines that the second information matches the condition based on the comparison, and associates the first information with the image data based on the determination.

### BRIEF DESCRIPTION OF THE DRAWINGS

FIG. 1 is a block diagram illustrating an exemplary configuration of an image information processing apparatus associated with the present disclosure;

FIG. 2 is a diagram illustrating exemplary contents of image data to be accepted by the image information processing apparatus associated with the present disclosure;

FIG. 3 is a diagram illustrating exemplary contents of an additional information setting table for use by the image information processing apparatus associated with the present disclosure;

FIG. 4 is a functional block diagram illustrating one example of the image information processing apparatus associated with the present disclosure;

FIG. 5 is a diagram illustrating an exemplary image data accumulation mode in the image information processing apparatus associated with the present disclosure;

FIG. 6 is a diagram illustrating a screen display example of the image information processing apparatus associated with the present disclosure;

FIG. 7 is a diagram illustrating another screen display example of the image information processing apparatus associated with the present disclosure;

FIG. 8 is a functional block diagram illustrating another example of an image information processing apparatus associated with the present disclosure;

FIG. 9 is a diagram illustrating exemplary contents of a special-day database for use by the image information processing apparatus associated with the present disclosure; and

FIG. 10 is a flowchart indicative of exemplary contents of processing to be executed by the image information processing apparatus associated with the present disclosure.

### DETAILED DESCRIPTION OF EMBODIMENTS

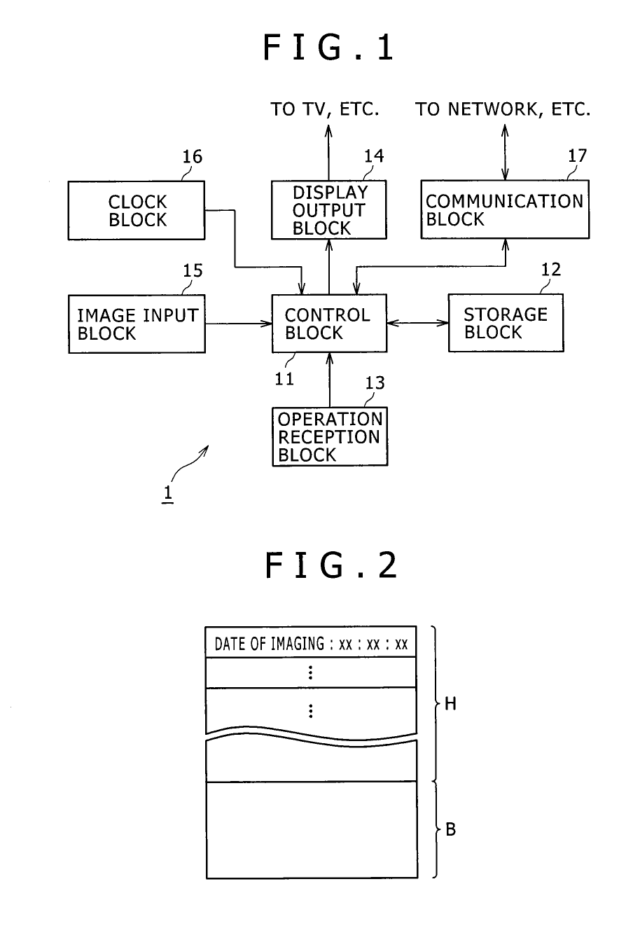

An image information processing apparatus 1 associated with the present disclosure has a control block 11, a storage block 12, an operation reception block 13, a display output block 14, an image input block 15, a clock block 16, and a communication block 17 as shown in FIG. 1. In some example of the present disclosure, the image information processing apparatus 1 is connected to a home television and a network (the Internet for example).

The control block 11 is a program-controlled device such as a CPU and therefore operates as instructed by a program stored in the storage block 12. In the present disclosure, the control block 11 functions as storage means that receives image data including at least one piece of additional information and accumulates the received image data for storage. It should be noted that this accumulation for storage denotes the storage of new image data in addition to old data rather than deleting the old data which is known as an overwrite save operation. In addition, the control block 11 functions as means of taking out additional information associated with an additional information adding condition satisfied by additional information included in received data among additional information adding conditions held in the storage block 12 that is holding means and as means of additionally including this taken out additional information into the received image data.

Further, the control block 11 functions as list providing means of providing a list of one or more extraction conditions, each thereof associated with at least one piece of additional information and as means of receiving the selection of an extraction condition from the provided list and extracting image data associated with the additional information satisfying the selected extraction condition from the accumulated image data, thereby presenting the extracted image data. A specific operation of this control block 11 will be detailed later.

The storage block 12 is configured by a memory device. The storage block 12 may also include a disk device such as a hard disk drive. The storage block 12 holds a program to be executed by the control block 11. This program is provided as stored in a computer-readable recording media such as a DVD-RAM for example and copied to the storage block 12 to be stored. This program may also be one that is downloaded from a server apparatus on a network. The storage block 12 operates also as a work memory of the control block 11. It should be noted that the storage block 12 may include a nonvolatile memory. Data (namely, data of parameters necessary for starting up the image information processing apparatus 1, for example) stored in the nonvolatile memory can be retained after the power to the nonvolatile memory is turned off.

Further, in the present disclosure, the storage block 12 accumulates image data for storage in accordance with instructions entered from the control block 11. In the present disclosure, image data is made up of the body (B) of image data and the header (H) (the additional information) as illustrated in FIG. 2. For one example, image data may be image data of Exif (Exchangeable image file format) including an image data body of JPEG (Joint Picture Experts Group) format taken by a digital camera and the like and a metadata block. The additional information may be included in this metadata block. Image data is not restricted to data of still images; namely, image data may also be data of moving images. In the case of moving image data, the data may be of the format in which a data body and additional information are included. The additional information includes such information added by a device such like a camera as the information about capture date, the information (so-called geotag) about latitude/longitude of capture location, and the information about the direction of the camera, for example. Further, the additional information of the present disclosure also includes the information such as character strings set by the user.

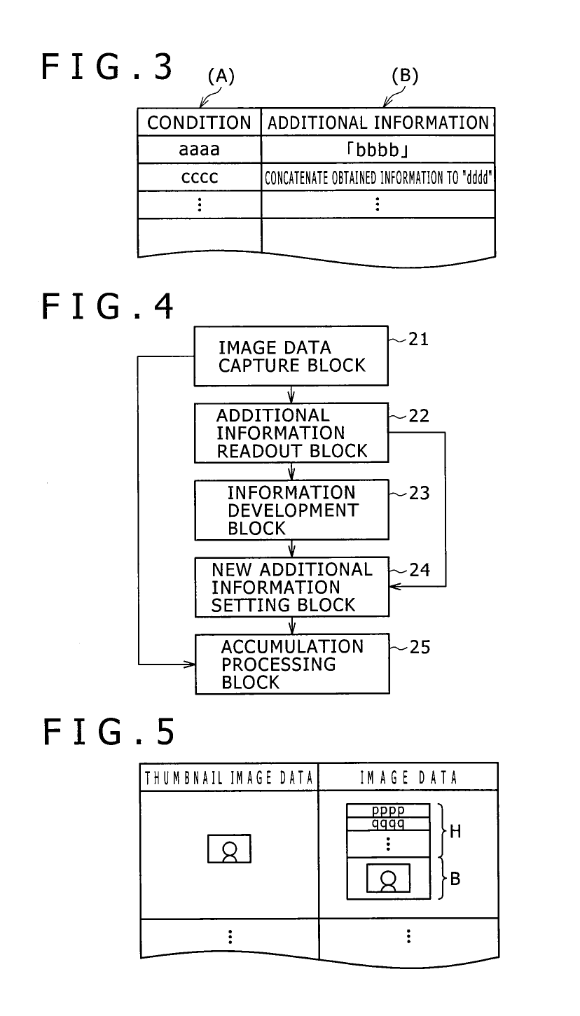

In addition, the storage block 12 holds a table (an additional information setting table) in which additional information adding condition associated with existing additional information is related with additional information to be further attached when a condition concerned is satisfied. For example, as shown in FIG. 3, this table relates additional information (B) to be newly attached with condition (A) based on existing additional information such as the relation between the information about capture date and a national holiday among the pieces of additional information included in image data.

The operation reception block 13 receives operational instructions from the user and outputs the received operational instructions to the control block 11. The operation reception block 13 includes button, switches, and other controls, for example. In addition, the operation reception block 13 may include a remote control unit configured to receive operational instructions from the user and a receiver configured to receive user operational instructions from this remote control unit in a wireless or wired manner. For example, the operation reception block 13 is made up of a unit configured to receive remote control signals carried by infrared radiation.

The display output block 14 outputs screen information indicative of screen images to be presented to the user to the outside in accordance with instructions received from the control block 11. The display output block 14 converts the screen information given from the control block 11 for example into television signals and outputs these television signals to an external television receiver.

The image input block 15 is an infrared ray receiver or a memory card reader, for example, and, in accordance with instructions entered from the control block 11, receives image data from any of these interfaces, outputting the received image data to the control block 11. The clock block 16 is configured by a calendar IC for example and counts date and time. The date and time counted by the clock block 16 are set by an instruction from the control block 11. The communication block 17 is a network interface for example and outputs data to the outside in accordance with instructions entered from the control block 11. In addition, the communication block 17 outputs data received from the outside to the control block 11.

The following describes the processing to be executed by the control block 11. The control block 11 of the present disclosure executes setting processing, image data capture processing, menu presentation processing, calendar display processing, an album arrangement processing, album display processing, and so on.

### [Setting Processing]

In accordance with an instruction given by the user, the control block 11 receives such settings as current date and time, screen design, display time (or slide show interval) for continuously displaying image data, screen ratio of a connected television receiver, birth date information of persons to be imaged, and so on, thereby setting or holding these pieces of information to or in the clock block 16 and storage block 12.

For example, when the user sets current date and time, the control block 11 overwrites the counted date and time of the clock block 16 with the contents of this setting. It is also practicable, when the information of name and birth date of a person to be imaged is entered, to relate these pieces of information with each other and hold the related information in the storage block 12 as a birthday database.

### [Image Data Capture Processing]

In an example of the present disclosure, the operation reception block 13 includes a “capture” switch arranged on the housing of the image information processing apparatus 1 associated with the present disclosure. When the user loads a memory card into a memory card reader for example of the image input block 15 and presses this “capture” switch, the control block 11 receives a signal indicative of this user operation to execute the following image data capture processing.

Functionally, this image data capture processing is made up of an image data capture block 21, an additional information readout block 22, an information development block 23, a new additional information setting block 24, and an accumulation processing block 25 as shown in FIG. 4.

When “capture” switch is pressed, the image data capture block 21 captures image data via the image input block 15. For example, if image data is stored in a memory card loaded on a memory card reader that is the image input block 15, the image data capture block 21 reads one piece of image data not yet read from this memory card and captures the read image data.

The additional information readout block 22 extracts additional information from the image data captured by the image data capture block 21. As described above, if the image data is of Exif format, then the additional information readout block 22 reads information included in a metadata block.

On the basis of the additional information read by the additional information readout block 22, the information development block 23 generates information of predetermined type or captures via the communication block 17. For example, the information development block 23 transmits a geotag to a predetermined server via the communication block 17 to receive and capture information about geographical name and facility name corresponding to the geotag. The predetermined server includes a positional reference information server provided by the Ministry of Land, Infrastructure, Transport and Tourism of Japan, the Google map service server provided by Google USA, and so on. Therefore, the description of details of these servers is skipped.

Another example of the information development block 23 is as follows. To be specific, if a birthday database is held in the storage block 12, the information development block 23 gets information about date and time to be counted by the clock block 16. The information development block 23 references the birthday database to compute a difference between the birth date information and the date and time information obtained from the clock block 16 for each of the persons whose birth dates are set to the birthday database, thereby computing age information (the number of years that passed from birth date to current data may be obtained). Then, the obtained age information (if the birth dates of two or more persons are recorded to the birthday database, the age information of each person) is stored.

The new additional information setting block 24 searches the conditions included in an additional information setting table stored in the storage block 12 for a condition that satisfies the additional information read by the additional information readout block 22 or the information obtained by the information development block 23. Then, the new additional information setting block 24 extracts the additional information recorded as related with the condition found by the search and add the extracted additional information to the image data. The conditions included in this additional information setting table are as follows for example. It should be noted that, in the following description, the data to which additional information is set is image data.
Condition 1. “The date of imaging is in a range from April 1 to April 10 and any one of “primary school,” “middle school,” “high school,” and “college” is included in facility name information obtained with respect to a geotag”

A character string “school entrance ceremony” for example is related with condition 1. If image data satisfying condition 1 is obtained, the new additional information setting block 24 sets the additional information of character string “school entrance ceremony” to the obtained image data.

It should be noted that the date and time information associated with the condition may not always include the information of date. For example, the following condition may be set.
Condition 2. “The time of imaging from 11:30 to 13:30 and the facility information obtained with respect to a geotag is ‘restaurant’

A character string “lunch” for example is related with condition 2. It should be noted that, in the additional information setting table, additional information related with a certain condition is not restricted to a fixed character string; for example, a character string obtained by combining a character string of a facility name obtained with respect to a geotag with “lunch” (for example, if a character string of a facility name obtained as associate with a geotag is “restaurant iroha,” a character string “restaurant iroha lunch” obtained by linking “restaurant iroha” with “lunch” may be used. In this case, when the image data satisfying condition 2 is obtained, then the new additional information setting block 24 generates a character string with the character string of a facility name obtained with respect to a geotag linked with the fixed character string “lunch” to set the additional information of the generated character string to the obtained image data.

In the above, the conditions associated with date and time of imaging are set by specifying start date and time and end date and time; however, the setting is not restricted thereto. For example, conditions may be set as follows.
Condition 3. “Date of imaging is January 1 and information about facilities obtained as related with a geotag is ‘shrines and temples’

Character string “new year's visit to shrine” is related with condition 3 as a fixed character string. In addition, a character string obtained by extracting a character string indicative of year from the date and time of imaging and combining the extracted character string with character string “new year's visit to shrine” may be related with condition 3 as additional information. In this case, when image data satisfying condition 3 is obtained, the new additional information setting block 24 generates a character string (for example, a character string such as “2011 new year's visit to shrine”) with a character string indicative of year extracted from the date and time of imaging with fixed character string “new year's visit to shrine” and sets the additional information of this generated character string to the obtained image data.

As described above, the additional information setting table may specify a character string to be generated from the information of the date and time of imaging of image data to which additional data is to be attached. For an example of this case, processing corresponding to condition 4 below is possible.

Condition 4. “Of birth dates d1, d2, . . . , included in the birthday database, there is a birth date with difference dc−di from date dc counted by the clock block 16 being below predetermined threshold dth”

Under this condition, it is assumed that the threshold dth be 100 days for example. This condition is satisfied if the passed days from birth date is equal to or less than 100 for example. For this condition, the passed days equivalent to the above-mentioned dc−di may be computed to provide, as additional information, a character string represented by use of character sting x of the computed passed days. In this case, a character string such as “x days after birth” is attached to the image data satisfying condition 4.

If the information development block 23 is computing information about the age of a person to be imaged, condition 4′ below may be used in place of condition 4:
Condition 4′. “Of the computed age information, there is 0 (age 0)”

Likewise,
Condition 5. “Information about facility obtained as related with imaging month of July or August and with a geotag is ‘seaside”

Character string “sea bathing” may be related with condition 5 as additional information to be set.

Further, only the information about geotag may be used for a condition as follows for example.
Condition 6. “Altitude information included in a geotag is in excess of a predetermined threshold”

Character string “moving in flight” may be related with this condition as additional information to be set.

Moreover, in another example of the present disclosure, a condition based on the relation between the information about date and time of imaging and the date included in the preset special-day database may be included as a condition in the additional information setting table. This special-day database is the accumulation of entries with dates (month name (any of the January through December) and date) related with special-day names in the storage block 12, one example of which includes entries with national holidays (in the case of Japan, the holidays stipulated by the National Holidays Act, for example) related with the names thereof

To be more specific, the following condition is set.
Condition 7. “Image date and time match any one of the dates included in the special-day database”

With respect to the condition, a character string having a name included in the entries with the date matched in the special-day database may be provided as the additional information to be set.

Another condition may be provided that, rather than matching a date of imaging with the date of a national holiday included in the special-day database, the difference in the number of days between a date of imaging and a national holiday date is within the predetermined threshold, for example. Further, this threshold may be different for each national holiday. For example, of the Japanese national holidays, the Respect-for-Senior-Citizens Day is designated on the third Monday of September; however, by considering situations that the events of the Respect-for-Senior-Citizens Day may actually take place on the Saturday and Sunday before or after this holiday, additional information of character string “Respect-for-Senior-Citizens Day” may be attached to the image data taken within three days of the Respect-for-Senior-Citizens Day, namely, from the last Saturday to the Respect-for-Senior-Citizens Day.

It should be noted that the new additional information setting block 24 may attach the information obtained by the information development block 23 directly to the image data as additional information without being dependent on the contents of the additional information setting table. For example, the information of a facility name obtained with respect to a geotag may be attached to the image data as additional information without change.

The accumulation processing block 25 generates thumbnail image data for the image data attached with additional information by the new additional information setting block 24, by reducing or enlarging this image data to a predetermined size. In addition, the accumulation processing block 25 includes, into this image data, the information of date obtained from the clock block 16 as the information indicative of the date of capture as additional information. Then, the accumulation processing block 25 relates this image data with the thumbnail image data to accumulate the related data in the storage block 12. This processing accumulates the image data attached with two or more pieces of additional information (H) into the storage block 12 along with the thumbnail image data of this image data as illustrated in FIG. 5.

### [Menu Presentation Processing]

The control block 11 also executes the processing of displaying the image data accumulated in the storage block 12. In the present disclosure, one of the following display modes is selected:

recently captured image data;

a list of image data at the date and time of imaging; and

a list of image data categorized by additional information (namely, album display).

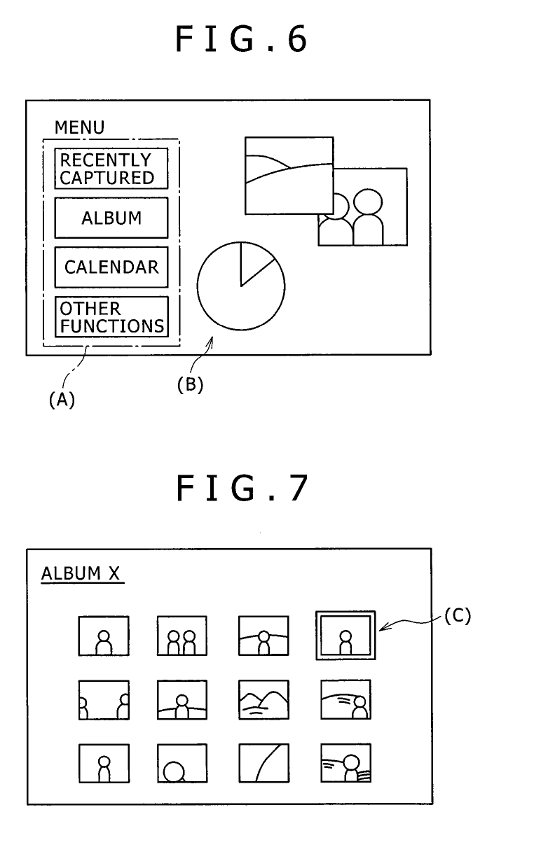

The control block 11 presents a screen illustrated in FIG. 6 for example after when the power to the image information processing apparatus 1 is turned on, for example. This screen a menu (A) (hereafter referred to as a top menu) and images (B) indicative of the capacity of an area available for accumulating image data and an occupied quantity (if image data is accumulated in a hard disk drive, the total capacity, used capacity, and free capacity of this hard disk drive) of the storage block 12.

The top menu has options “recently captured images,” “album,” “calendar,” and “other functions,” for example. If the user selects “recently captured images” for example, the control block 11 stores “recently captured images” as a list extraction condition information and gets information indicative of the current date and time from the clock block 16. Next, of the image data accumulated in the storage block 12, the control block 11 extracts the date and time of capture included in the additional information and the image data with a difference from the current date and time of capture being below a predetermined threshold (less than six days for example) and displays a list of thumbnail image data related with the extracted image data (refer to FIG. 7).

When the user selects “album” from the above-mentioned top menu, the control block 11 generates a list (duplicate description skipped) of the additional information included in the image data stored in the storage block 12 and presents at least a part of the generated list as a list of albums. Then, when the user selects any additional information from the presented list as an extraction condition, the control block 11 stores this selected additional information as list extraction condition information and extracts the image data including this selected additional information from the image data stored in the storage block 12. Next, the control block 11 reads the thumbnail image data related with the extracted image data from the storage block 12 and displays a list of the thumbnail image data. To be more specific, in the present disclosure, a list of additional information is presented as a list of extraction conditions; however, it is controlled that this list of extraction conditions excludes any additional information (any extraction conditions with the image data selected by an extraction condition concerned not accumulated) not actually attached to image data. That is, even if there is information to be added as additional information in advance, such as a national holiday, any album associated with any additional information having no actually attached image data is handled as that there is no such an album, resulting in the provision of an interface that looks natural to the user.

Further, in the present disclosure, actually attached additional information or a part thereof is used as a name of “album” as described above. This allows the categorization of image data into two or more albums for example by including the additional information associated with two or more albums into image data rather than copying image data and recording the copied image data duplicatively to recording areas (directories for example) corresponding to the albums.

### [Processing to be Executed During Display]

The control block 11 displays a cursor for pointing any one piece of thumbnail image data included in a list during list display for example (refer to FIG. 7(C)). The control block 11 receives a cursor move or select operation signal from the user and, in accordance with the operation done, moves the cursor to another thumbnail image data. When the control block 11 receives a select operation signal, the control block 11 reads the image data associated with the thumbnail image data pointed by the cursor from the storage block 12 to display the image data in place of the list image.

In addition, when an operation is done by the user in order to display the menu, the control block 11 displays a menu that includes optional items such as “further search,” “put in album,” “edit preference,” “move to trash box,” and so on, for example. It should be noted that, if list display is executed starting with the selection of “album,” then the control block 11 may include, in this menu, album-unique selection items such as “edit album” for example.

When the user selects “further search,” the control block 11 requests the user for entering a new search condition. To be more specific, the control block 11 generates a list (duplicate description skipped) of the additional information included in the image data stored in the storage block 12 and presents at least a part (for example, by selecting the additional information included in the image data associated with the thumbnail data currently being displayed in list) of the generated list. Then, when the user selects any of the additional information from the presented list, the control block 11 extracts the thumbnail image data with the selected additional information included in the associated image data among the currently presented thumbnail image data, thereby newly displaying a list of the extracted thumbnail image data.

When “put in album” is selected by the user from the menu display in list, the control block 11 generates a list (duplicate description skipped) of the additional information included in the image data stored in the storage block 12 and presents at least a part (except for the additional information equivalent to the list extraction condition information for example) of the generated list. Then, when the user selects any additional information (referred to as information subject to attachment) from the presented list, the control block 11 requests the user for selecting at least one piece of thumbnail image data from the currently displayed thumbnail image data. The user executes cursor move and select operations to select at least one piece of the thumbnail image data and then executes an operation to indicate that the selection has terminated. For at least one piece of thumbnail image data selected by the user, the control block 11 attaches the additional information subject to attachment to the image data associated with the selected thumbnail image data.

Further, when “edit preference” is selected by the user from the menu displayed in list, the control block 11 superimposes an image (an image of star for example) indicative that “preference” is set onto the thumbnail image data with the additional information (for example, a control code thereof that cannot be accessed by the user with a normal operation) indicative of “preference” included in the associated image data among the thumbnail image data currently display in list.

When the user executes cursor move and select operations for example in order to select the thumbnail image data included in the list, the control block 11 switches the setting of “preference” associated with the selected thumbnail image data. To be more specific, if additional information indicative of “preference” is included in the image data associated with the selected thumbnail image data, the control block 11 deletes this additional information indicative of “preference.” On the other hand, if additional information indicative of “preference” is not included in the image data associated with the selected thumbnail image data, then the control block 11 attaches the additional information indicative of “preference.”

When the user further selects “edit album” from the menu currently display in list, then the control block 11 superimposes an image (an image of star for example) indicative of the inclusion in an album onto the thumbnail image data with the same additional information as the list extraction condition information in the associated image data among the thumbnail image data currently displayed in list.

Next, when the user selects the thumbnail image data included in the list by executing cursor move and select operations for example, then the control block 11 switches whether to include the image data associated with the selected thumbnail image data into the album or not. To be more specific, if the same additional data as the list extraction condition information is included in the image data associated with the selected thumbnail image data, the control block 11 deletes the same additional information as the list extraction condition information. If the same additional information as the list extraction condition information is not included in the selected thumbnail image data, then the control block 11 attaches the additional information stored as list extraction condition information.

### [Setting Memorial Days]

The control block 11 may also receive an instruction for setting, as a “memorial day,” a given date (a date identified by month and day) from the user in order to execute memorial day setting processing. In this processing, the control block 11 receives month (one of January through December) and day and a name of memorial day. Here, the name of memory day is handled as additional information.

The control block 11 relates the information about entered month and day with the additional information to include the related information into the special-day database to be stored in the storage block 12. By making the special-day database ready for update as described above, when the user of the image information processing apparatus 1 of the present disclosure sets a user-unique memorial day, a wedding anniversary for example, the control block 11 attaches the additional data that is “wedding anniversary” to image data when the image data with the date of imaging matching the date set as the wedding anniversary is captured.

This processing also allows the selection of the album having name “wedding anniversary,” so that the list display of this album shows the image data taken at the date set as “wedding anniversary.”

It should be noted that the events associated with memorial days and holidays do not always take place exactly on the dates concerned as described above. Therefore, in the present disclosure, a range before and after a particular preset date such as a memory day may be set. This range may be the predetermined number of days (three days before and two days after a preset date for example) or a range extending from the last Saturday to the next Sunday for example by using day-of-the-week information. Alternatively, the range may be set by specifying the start and end dates thereof. In these cases, the special-day database contains the information indicative of the range and the additional information related therewith.

The information indicative of the above-mentioned range may be different from entry to entry. For example, with the New Year's Day of January 1, the information indicative of the range includes “January 1” indicative of the target date itself, the information (“0” day) indicative of the start of the range, and the information (“0” day) indicative of the end of the range. Also, with the Coming-of-Age Day, a Japanese national holiday, the ceremonies are often carried out on Saturday and Sunday before and after the day, so that information including “the second Monday of January” indicative of the Coming-of-Age Day and information indicative of “the range from the last Saturday to the next Sunday” around this holiday is set as the information indicative of the range.

### [Attaching Additional Information]

Further, the control block 11 of the image information processing apparatus 1 of the present disclosure may set new entries of the additional information setting table as instructed by the user. In this case, the user enters an additional information setting condition and the additional information to be set. For example, the user enters condition “the month of imaging is November and “shrine” is included in facility information obtained with respect to a geotag” and character string “7-5-3” as additional information. The control block 11 relates this condition with this additional information and stores the related condition and additional information into the additional information setting table. It should be noted that “7-5-3” denotes a Japanese annual event cerebrating the sound growth of children at ages seven, five, and three.

The above-mentioned setting allows the control block 11 to attach additional information “7-5-3” to captured image data when the captured image data including “shrine” in facility information to be obtained in association with a geotag indicative of the location of imaging and the date of imaging is during November.

In addition, the above-mentioned setting allows the user to select an album having name “7-5-3.” The list display of this album displays a list of the thumbnail image data associated with the image data taken during November as the image data included in album “7-5-3” and including “shrine” in the facility information obtained in association with a geotag indicative of location of imaging.

### [Re-Attachment Processing at Newly Adding Additional Information]

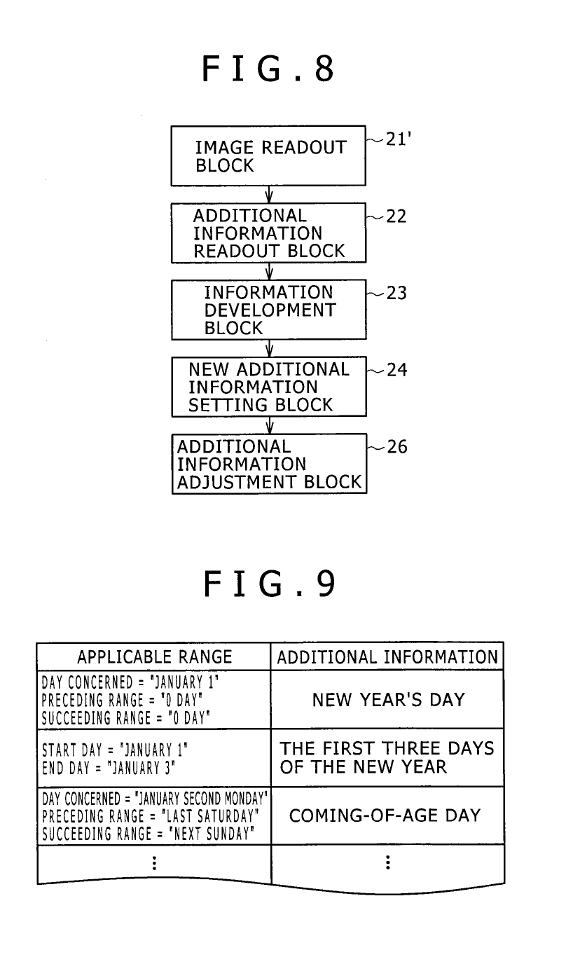

When entries of the additional information setting table and memorial days are newly added, the control block 11 may execute processing of attaching additional information again on the image data accumulated in the storage block 12. This processing is approximately the same as the image data capture processing illustrated in FIG. 4. The control block 11 configured to execute this processing functionally has an image readout block 21’, an additional information readout block 22, an information development block 23, a new additional information setting block 24, and an additional information adjustment block 26 as illustrated in FIG. 8. It should be noted that the blocks similar in configuration to those previously described with reference to FIG. 4 are denoted by the same reference numerals and the description thereof will be skipped.

The image readout block 21′ sequentially reads the image data stored in the storage block 12, piece by piece, thereby getting the read image data. For the image data attached with new additional data by the new additional information setting block 24, the additional information adjustment block 26 checks whether two or more pieces of the same additional information are duplicatively included or not. If two or more pieces of the same additional information are found included, then these additional information are deleted by retaining only one piece. This prevents the same pieces of additional information from being attached duplicatively.

### [Operation]

The image information processing apparatus 1 of the present disclosure has the above-mentioned configuration and operates as follows. The following description will be made by use of an example in which the image data taken by the user with a camera having a GPS function (a camera that attaches geotags to image data) is managed by the this image information processing apparatus 1. It is assumed, in the following description, that entries in which the information indicative of “second Monday of January” indicative of Coming-of-Age Day, the range including the information “from the last Saturday to the next Sunday” around this holiday, and character string “Coming-of-Age Day” as additional information be related with each other are recorded to the storage block 12 of the image information processing apparatus 1 as a special-day database as shown in FIG. 9.

In this example, it is also assumed that the Coming-of-Age ceremony customarily carried out in Japan be held on January 14, Sunday immediately before January 15 which is statutorily specified to be Coming-of-Age Day and the user who took photographs at the Coming-of-Age ceremony load the image data of these photographs into the image information processing apparatus 1.

When the user takes out a memory card in which the image data is recorded from the camera, loads this memory card into the image input block 15 of the image information processing apparatus 1, and presses “capture” switch, the image information processing apparatus 1 sequentially selectively reads the image data not yet read among the image data recorded to the memory card.

Checking whether there is any image data not yet read or not is executed as follows, for example. For each piece of the image data stored in the storage block 12, the image information processing apparatus 1 of the present disclosure computes a unique hash value by a predetermined method. This hash value may be a known value such as MD5 for example. Then, the image information processing apparatus 1 holds a list of the computed hash values in the storage block 12.

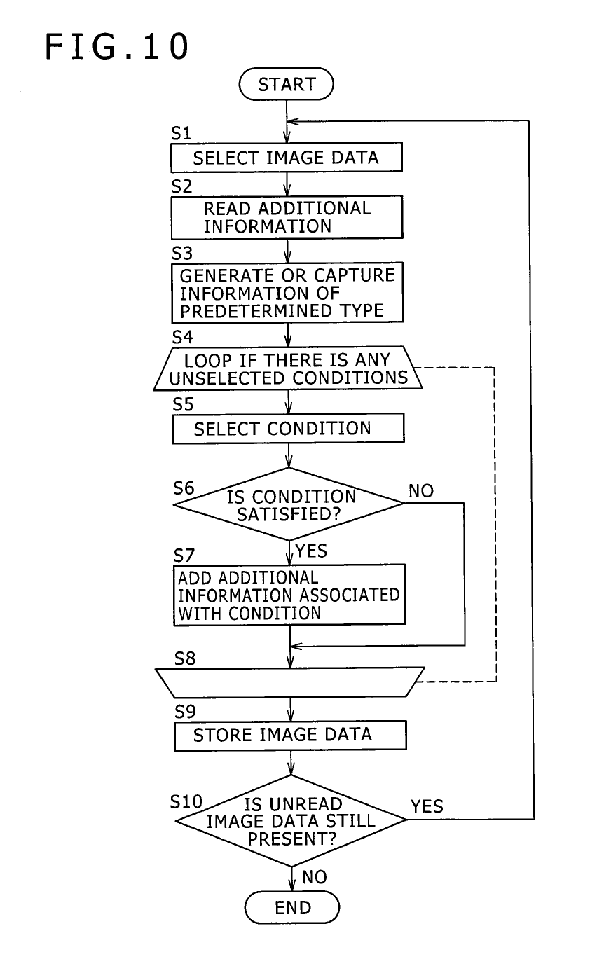

Next, of the image data stored in a memory card, the image information processing apparatus 1 extracts the image data with the hash value computed by the above-mentioned method not included in the list stored in the storage block 12. Consequently, the image data not yet read is extracted. As illustrated in FIG. 10, the image information processing apparatus 1 selects one of the extracted pieces of image data (S1).

The image information processing apparatus 1 reads the selected image data and then reads additional information from the read image data that is subject to processing (S2). Then, on the basis of the read additional information, the image information processing apparatus 1 generates information of a predetermined type (S3). In the processing S3, the image information processing apparatus 1 may get the information of a predetermined type on the basis of the read additional information by the communication via the communication block 17.

To be more specific, a geotag among the additional information read from the image data subject to processing is transmitted to a predetermined server via the communication block 17 to receive and get the geographical name and facility name corresponding to the geotag. For example, in the case of the image data of photographs taken at the school entrance ceremony of the child of the user, character string “primary school” is included in the information of geographical name and facility name obtained on the basis of the geotag.

The image information processing apparatus 1 starts a loop operation (S4) until there is no unselected condition among the conditions included in the additional information setting table stored in the storage block 12 to select one unselected condition (S5), thereby determining whether the additional information read in the processing S2 or the information obtained in the processing S3 satisfies the condition selected in the processing S5 (S6).

Now, it is assumed that “date of imaging is in a range from April 1 to April 10 and any one of “primary school,” “middle school,” “high school,” and “college” is included in facility name information obtained with respect to a geotag” be included in the additional information setting table as a condition (hereafter referred to as condition “a”), then, because the date of imaging of the image data in this example is January 14, condition a is determined not to be satisfied.

It is also assumed that condition “the date of imaging is included in the range of entries included in the special-day database” be included in the additional information setting table as a condition (hereafter referred to as condition “b”). In this example, because January 14, the date of imaging, is Sunday immediately before January 15, Coming-of-Age Day, the date of imaging is within the range of Coming-of-Age Day identified by the information included in the special-day database, thereby satisfying condition “b.”

In the processing S6, upon determining that the condition has been satisfied (Yes), the image information processing apparatus 1 takes out the additional information held in the additional information setting table as related with this condition and attaches this additional information to the image data subject to processing (7).

If condition “the date of imaging is included in this range of entries included in the special-day database” is related with additional information “the additional information related with this range,” then character string “Coming-of-Age Day” that is additional information associated with Coming-of-Age Day is taken out to be attached to the image data of this example.

If there is any unselected conditions, the image information processing apparatus 1 repeats the above-mentioned loop operation from the processing S4 (S8). Getting out of this loop of the processing S4 to the processing S8, the image information processing apparatus 1 generates thumbnail image data based on the image data subject to processing and relates the generated thumbnail image data with the image data subject to processing, storing the related data into the storage block 12 (S9). Then, the image information processing apparatus 1 determines whether there is any image data not yet read in the memory card (S 10). If there is any (Yes), then the image information processing apparatus 1 returns to the processing Si to repeat the above-mentioned processing operations therefrom. If there is no unread image data (No), the processing comes to an end.

If the condition is found not satisfied in the processing S6 (No), then the image information processing apparatus 1 goes to the processing S8 to continue the processing.

When the above-mentioned processing has been completed, the image information processing apparatus 1 executes top-menu display processing, thereby displaying a menu for letting user select display modes such as “recently captured” or album display as shown in FIG. 6 for example. If the user selects “album” for example from the menu, the image information processing apparatus 1 generates a list (duplicate description skipped) of additional information included in the image data accumulated in the storage block 12 and presents at least a part of the generated list, additional information except for the information of predetermined types such as the date of imaging and geotags for example, as a list of albums.

In this example, some pieces of accumulated image data are attached with additional information such as “Coming-of-Age Day” as described above among the accumulated image data. Therefore, this list includes character string “Coming-of-Age Day.”

When the user selects “Coming-of-Age Day” from the presented list, the image information processing apparatus 1 stores the additional information selected as list extraction condition information, extracts image data including the selected additional information “Coming-of-Age Day” from the image data stored in the storage block 12, and reads the thumbnail image data related with the extracted image data from the storage block 12, thereby displaying the list.

Next, the image information processing apparatus 1 displays the cursor for pointing any one of the pieces of thumbnail image data included in the list, receives an operation signal indicative of a cursor move or select operation done by the user, reads the image data related with the thumbnail image data pointed by the cursor at the time of select operation from the storage block 12, thereby displaying this image data in place of the list image.

### [Variations]

It should be noted that the conditions that can be set to the additional information setting table are not restricted to those described above. For example, a condition associated with character strings obtained from image data through an OCR (Optical Character Reader) may also be set to the additional information setting table. For example, a condition “character string ‘festival’ is included” obtained as a result of OCR processing may be set to this table. To this condition, additional information “festival” may be attached for example.

The information about the ages of persons who can be subjects of imaging obtained from the birthday database set by the user may also be used. For example, at the date of imaging, a condition may be set that a person in the range of 5 or more years old to less than 7 years old be set to the birthday database and the date of imaging be in the range of April 1 to April 15, and “primary school” be included in the facility name information obtained on the basis of a geotag.

Further, an event name may be obtained from a geotag and the information about date of imaging. For example, for the information about location and facility name, “vicinity of Tamagawa river” is obtained on the basis of a geotag, the date of imaging and the facility name information are transmitted to a search engine on the Internet via the communication block 17 and, when the matching information including a predetermined event name template (character string “festival,” “fire work event,” “event,” “flea market,” or the like) is found, the character string matching the even name template concerned is obtained as additional information.

Alternatively, a server for relating event names with geotags and information about date of imaging and holding the related information may be prepared that is accessed by the image information processing apparatus 1 to obtain an event name, thereby using the obtained event information as additional information.

While preferred embodiments of the present disclosure have been described using specific terms, such description is for illustrative purpose only, and it is to be understood that changes and variations may be made without departing from the spirit or scope of the following claims.

What is claimed is:

1. An information processing apparatus comprising:
a database that stores a condition associated with first information;
a memory that stores image data and second information associated with the image data; and
a processor that
compares the second information to the condition;
determines that the second information matches the condition based on the comparison; and
associates the first information with the image data based on the determination.

2. The information processing apparatus of claim 1, wherein
the first information and second information are metadata.

3. The information processing apparatus of claim 1, wherein
the condition associated with the first information includes a range of metadata parameters.

4. The information processing apparatus of claim 3, wherein
the processor determines that the second information matches the condition when the second information falls within the range of metadata parameters.

5. The information processing apparatus of claim 1, wherein
the condition associated with the first information includes a plurality of metadata parameters.

6. The information processing apparatus of claim 5, wherein
the processor determines that the second information matches the condition when the second information matches the plurality of metadata parameters.

7. The information processing apparatus of claim 1, wherein
the condition associated with the first information includes at least a date and a location.

8. The information processing apparatus of claim 7, wherein
the processor determines that the second information matches the condition when the second information includes information corresponding to the at least the date and location included in the condition.

9. The information processing apparatus of claim 1, wherein
the condition associated with the first information includes a time range and a location.

10. The information processing apparatus of claim 9, wherein
the processor determines that the second information matches the condition when the second information includes information corresponding to the time range and the location included in the condition.

11. The information processing apparatus of claim 1, further comprising:
a user interface including a display that displays the condition in relation to the first information with which it is associated.

12. The information processing apparatus of claim 11, wherein
the user interface receives an input corresponding to the condition, and
the processor acquires image data from the memory based on the received input and controls the user interface to display the acquired image data.

13. The information processing apparatus of claim 1, further comprising:
a user interface that receives an input corresponding to at least one of a date, time, location and event.

14. The information processing apparatus of claim 13, wherein
the processor acquires image data from the memory that includes second information matching the at least one of the date, the time, the location and the event from the memory and controls the user interface to display the acquired image data.

15. The information processing apparatus of claim 1, further comprising:
a user interface that receives an input corresponding to a second condition associated with third information.

16. The information processing apparatus of claim 13, wherein
the processor generates an association between the second condition and the third information and controls the database to store the association between the second condition and the third information.

17. An information processing method performed by an information processing apparatus, the method comprising:
storing a condition associated with first information in a database;
storing image data and second information associated with the image data in a memory;
comparing the second information to the condition;
determining that the second information matches the condition based on the comparison; and
associating the first information with the image data based on the determination.

18. A non-transitory computer-readable medium including computer program instructions, which when executed by an information processing apparatus, cause the information processing apparatus to perform a method, the method comprising:
storing a condition associated with first information in a database;
storing image data and second information associated with the image data in a memory;
comparing the second information to the condition;
determining that the second information matches the condition based on the comparison; and
associating the first information with the image data based on the determination.
